(19) United States
(12) Patent Application Publication
(10) Pub. No.: US 2026/0117699 A1
(43) Pub. Date: Apr. 30, 2026

(54) PYLON-MOUNTED BOTTOMING CYCLE

(71) Applicant: RTX CORPORATION, Farmington, CT (US)

(72) Inventors: Simon W. Evans, Farmington, CT (US); Brandon M. Evans, San Antonio, TX (US)

(21) Appl. No.: 19/431,335

(22) Filed: Dec. 23, 2025

Related U.S. Application Data
(63) Continuation-in-part of application No. 18/770,854, filed on Jul. 12, 2024.
Application No. 18/770,854 is a continuation-in-part of application No. 17/871,270, filed on Jul. 22, 2022, now Pat. No. 12,560,124.

(51) Int. Cl. F02C 6/18; F02C 3/22; F02C 7/224

(52) U.S. Cl. CPC F02C 6/18; F02C 3/22; F02C 7/224; F05D 2220/323; F05D 2220/62; F05D 2260/213

(57) ABSTRACT

An aircraft propulsion system includes a primary energy conversion device that uses a cryogenic fuel and air to generate power and thermal energy, a pylon that is configured to support the primary energy conversion device, the pylon includes an interior space, a bottoming cycle that is supported within the interior space of the pylon, the bottoming cycle includes a working fluid that is circulated within a closed circuit that includes a bottoming compressor section and a bottoming turbine section, the working fluid is compressed in the bottoming compressor section and expanded through the bottoming turbine section to generate shaft power, a primary heat exchanger that is configured to communicate thermal energy that is generated by the primary energy conversion device into the working fluid, and a fuel/working fluid heat exchanger that is configured to transfer thermal energy from the working fluid into the cryogenic fuel.

### CROSS REFERENCE TO RELATED APPLICATION

This application is a continuation-in-part of U.S. Application Ser. No. 18,770,854 filed on Jul. 12, 2024, which is a continuation-in-part of U.S. application Ser. No. 17/871,270 filed on Jul. 22, 2022. The disclosures of U.S. application Ser. Nos. 17/871,270 and 18/770,854 are incorporated by reference in their entirety in this application.

### TECHNICAL FIELD

The present disclosure relates generally to a bottoming cycle for an aircraft propulsion system and more specifically to a pylon mounted bottoming cycle.

### BACKGROUND OF THE INVENTION

Gas turbine engines typically include a compressor where inlet air is compressed and delivered into a combustor. In the combustor, the compressed air is mixed with fuel and ignited to generate an exhaust gas flow. The exhaust flow is expanded through a turbine section to generate shaft power used to drive the compressor and a propulsive fan. Some energy in the high energy exhaust flow is recovered as it is expanded through a turbine section. However, a large amount of energy in the form of heat is simply exhausted from the turbine section to the atmosphere. A bottoming cycle utilizes recovered heat to generate additional useful work. A working fluid in the bottoming cycle is heated to drive a secondary turbine to generate additional shaft power. The working fluid in the bottoming cycle is then cooled, compressed, and reheated before expansion back through the turbine. The capability of the working fluid to accept heat may limit energy recovery of the bottoming cycle. Moreover, components of the bottoming cycle require additional space that may limit application.

### SUMMARY OF THE INVENTION

An aircraft propulsion system according to an exemplary embodiment of this disclosure, among other possible things includes a primary energy conversion device that uses a cryogenic fuel and air to generate power and thermal energy, a pylon that is configured to support the primary energy conversion device, the pylon includes an interior space, a bottoming cycle that is supported within the interior space of the pylon, the bottoming cycle includes a working fluid that is circulated within a closed circuit that includes a bottoming compressor section and a bottoming turbine section, the working fluid is compressed in the bottoming compressor section and expanded through the bottoming turbine section to generate shaft power, a primary heat exchanger that is configured to communicate thermal energy that is generated by the primary energy conversion device into the working fluid, and a fuel/working fluid heat exchanger that is configured to transfer thermal energy from the working fluid into the cryogenic fuel.

In a further embodiment of the foregoing, the aircraft propulsion further includes a fuel system that includes a cryogenic fuel storage tank and a fuel flow path for routing a flow of the cryogenic fuel to the primary energy conversion device. Thermal energy is transferred into the flow of the cryogenic fuel within the fuel/working fluid heat exchanger.

In a further embodiment of any of the foregoing aircraft propulsion systems, the primary energy conversion device includes a gas turbine engine that includes a combustor where a flow of the cryogenic fuel is mixed with compressed air and ignited to generate an exhaust gas flow, and the exhaust gas flow is expanded through a turbine section to generate shaft power that is utilized to drive a propulsive fan. The exhaust gas flow is communicated through the primary heat exchanger for heating the working fluid.

In a further embodiment of any of the foregoing aircraft propulsion systems, the primary heat exchanger is mounted aft of the primary energy conversion device and outside of the interior space of the pylon.

In a further embodiment of any of the foregoing aircraft propulsion systems, the fuel/working fluid heat exchanger is mounted within the interior space of the pylon.

In a further embodiment of any of the foregoing, the aircraft propulsion system further includes a generator that is disposed within the interior space of the pylon. The generator is driven by the bottoming turbine section through a drive shaft.

In a further embodiment of any of the foregoing, the aircraft propulsion system further includes a secondary heat exchanger that is configured to transfer thermal energy from a secondary heat source into the working fluid within a secondary heat exchanger.

In a further embodiment of any of the foregoing, the aircraft propulsion system further includes a bottoming cycle heat exchanger that is configured to communicate thermal energy from a secondary heat source into the working fluid.

In a further embodiment of any of the foregoing aircraft propulsion systems, a portion of the closed circuit communicates the working fluid with a cooling flow separate from the cryogenic fuel in a supplemental heat exchanger.

In a further embodiment of any of the foregoing aircraft propulsion systems, the primary energy conversion device includes a fuel cell that uses the cryogenic fuel and oxygen to generate electric power.

An aircraft propulsion system according to another exemplary embodiment of this disclosure, among other possible things includes a core engine that includes a compressor, combustor, and turbine where a cryogenic fuel is mixed with compressed air from the compressor in the combustor and ignited to generate an exhaust gas flow that is expanded through the turbine to generate shaft power. A propulsive fan is coupled to be driven by the turbine, a pylon is configured to support the core engine and the propulsive fan, the pylon includes an interior space, a bottoming cycle is supported within the interior space of the pylon, the bottoming cycle includes a working fluid that is circulated within a closed circuit that includes a bottoming compressor section and a bottoming turbine section, the working fluid is compressed in the bottoming compressor section and expanded through the bottoming turbine section to drive a drive shaft, a primary heat exchanger is configured to communicate thermal energy from the exhaust gas flow into the working fluid, a fuel system includes a cryogenic fuel storage tank and a fuel flow path for routing a flow of the cryogenic fuel to the core engine, and a fuel/working fluid heat exchanger is configured to transfer thermal energy from the working fluid to the flow of the cryogenic fuel.

In a further embodiment of the foregoing aircraft propulsion system, the primary heat exchanger is mounted to the pylon aft of the core engine and the fuel/working fluid heat exchanger are mounted within the interior space of the pylon.

In a further embodiment of any of the foregoing, the aircraft propulsion system further includes a generator that is coupled to the drive shaft. The generator is supported within the interior space of the pylon.

In a further embodiment of any of the foregoing aircraft propulsion systems, the fuel/working fluid heat exchanger is mounted within the interior space of the pylon.

In a further embodiment of any of the foregoing, the aircraft propulsion system further includes a secondary heat exchanger that is configured to transfer thermal energy from a secondary source into the working fluid.

In a further embodiment of any of the foregoing, the aircraft propulsion system further includes a bottoming cycle heat exchanger that is configured to transfer thermal energy from a secondary heat source into the working fluid.

In a further embodiment of any of the foregoing aircraft propulsion systems, a portion of the flow of working fluid within the closed circuit is in thermal communication with a cooling flow within a secondary heat exchanger.

A method of operating an aircraft propulsion system according to another exemplary embodiment of this disclosure, among other possible things includes communicating thermal energy from a heat source into a working fluid within a primary heat exchanger to generate a heated working fluid flow circulating within a closed circuit of a bottoming cycle supported within an interior space of a pylon, generating shaft power with the bottoming cycle by compressing a flow of the working fluid that is communicated through the closed circuit from the interior space of the pylon to the primary heat exchanger and expanding the flow of the heated working fluid flow through a bottoming turbine section to drive a drive shaft, and cooling the flow of the working fluid with a flow of cryogenic fuel within a fuel/working fluid heat exchanger.

In a further embodiment of the foregoing method, the fuel/working fluid heat exchanger is disposed within the interior space of the pylon.

In a further embodiment of any of the foregoing, the method further includes communicating thermal energy from a secondary source into the flow of working fluid after heating within the primary heat exchanger.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example aircraft propulsion system including a bottoming cycle disposed within a pylon.

FIG. 2 is simplified schematic view of the example aircraft propulsion system shown in FIG. 1.

FIG. 3 is a schematic view of another example aircraft propulsion system including a bottoming cycle.

FIG. 4 is a schematic view of another example aircraft propulsion system including a fuel cell and a bottoming cycle.

FIG. 5 is a schematic view of an example bottoming cycle implemented within a pylon structure.

### DETAILED DESCRIPTION

U.S. application Ser. Nos. 18/770,854 and 17/871,270 are incorporated herein, by reference in their entirety.

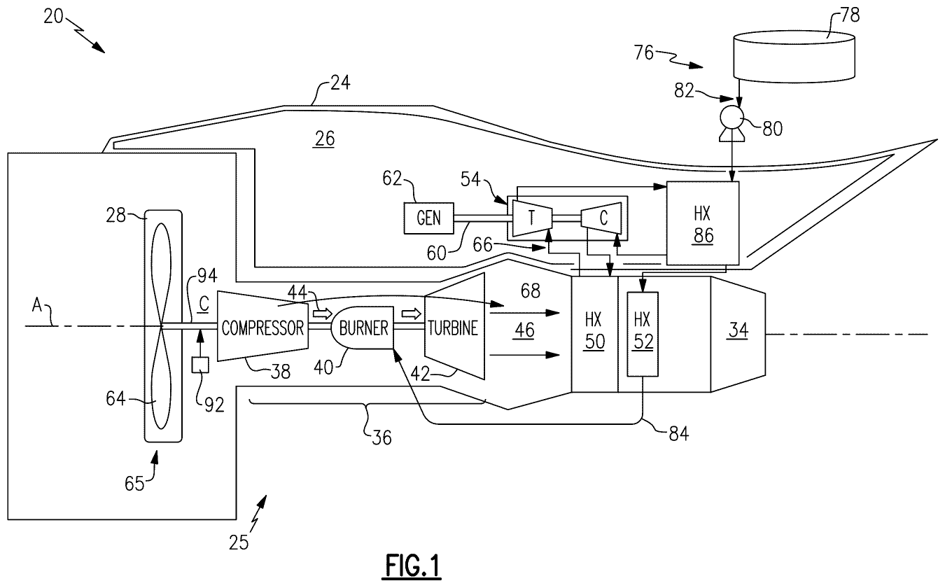

Referring to FIG. 1, an aircraft propulsion system 20 is schematically shown and includes a bottoming cycle 54 that generates shaft power from heat recovered from gas turbine engine assembly 25. The gas turbine engine assembly 25 includes a core engine 36 that drives a propulsor section 65. The bottoming cycle 54 is supported within a pylon 24 that supports the turbine engine assembly 25. Mounting of the bottoming cycle 54 within the pylon 24 enables implementation without substantial modification to structures of the gas turbine engine assembly 25. Moreover, incorporation of the bottoming cycle 54 into the pylon 24 may enable adoption and use in aircraft and engine architectures that may not otherwise have sufficient available space.

The gas turbine engine assembly 25 includes the propulsor section 65 driven by the core engine 36. The example propulsor section 65 includes a fan case 28 that surrounds a fan 64. Although an example embodiment includes the fan case 28, other engine architectures and propulsor configurations may be used and are within the contemplation and scope of this disclosure. For example, an open fan rotor propulsive fan may be utilized and would benefit from this disclosure.

A cryogenic fuel system 76 includes at least a fuel storage tank 78 and a fuel pump 80 to provide a liquid fuel flow 82 to a combustor 40. The example fuel system 76 is configured to provide a hydrogen based fuel such as a liquid hydrogen (LH₂). Although hydrogen is disclosed by way of example, other cryogenic fuels could be utilized and are within the contemplation of this disclosure. The liquid fuel flow 82 is transformed into a gaseous flow 84 with heat from the exhaust gas flow 46 communicated within an exhaust gas heat exchanger 52. The gaseous flow 84 is then injected into the combustor 40.

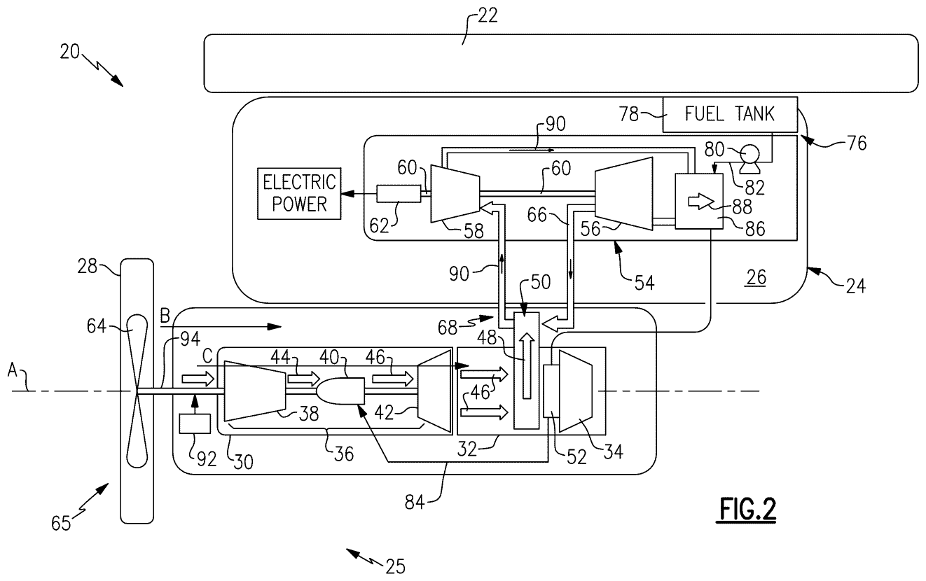

Referring to FIG. 2, with continued reference to FIG. 1, the core engine 36 is supported within a core case 30. The core case 30 is attached to a turbine exhaust case 32 that surrounds the hot section of the core engine 36. The core case 30, and thereby the gas turbine engine assembly 25 is supported by the pylon 24. The pylon 24 is attached to an aircraft structure that is schematically indicated at 22. The aircraft structure 22 may be part of a wing or fuselage of an aircraft.

The bottoming cycle 54 includes a closed circuit 66 where a working fluid 90 is compressed, heated, and then expanded through a bottoming turbine 58 to generate power. The working fluid 90 is heated by an exhaust gas flow 46 within a primary heat exchanger 50. The example primary heat exchanger 50 is disposed aft of the core engine 36 before an exhaust nozzle 34.

The pylon 24 defines an interior space 26. Locating the bottoming cycle 54 within the interior space 26 of the pylon 24 does not require additional space within or around the core case 30. The interior space 26 includes a volume that may be enclosed or covered.

The example propulsion system 20 includes the core engine 36 that generates shaft power utilized to drive the propulsive fan 64. The example core engine 36 includes a core flow path C through a compressor 38, a combustor 40 and the turbine 42 disposed along the longitudinal axis A. The fan 64 drives an inlet airflow into the compressor 38. The compressed inlet airflow is communicated as a pressurized core flow 44 to the combustor 40 where it is mixed with a fuel flow 84 and ignited to generate the exhaust gas flow 46. The exhaust gas flow 46 expands through the turbine 42 where energy is extracted and utilized to generate shaft power to drive an engine shaft 94. The engine shaft 94 drives the compressor 38 and the fan 64. The exhaust gas flow 46 is subsequently exhausted through a nozzle 34.

Although an example engine architecture is disclosed by way of example, other turbine engine architectures are within the contemplation and scope of this disclosure. Moreover, although the disclosed non-limiting embodiment depicts a turbofan turbine engine, it should be understood that the concepts described herein are not limited to use with turbofans as the teachings may be applied to other types of turbine engines. Additionally, the features of this disclosure may be applied to other engine configurations utilized to generate shaft power.

The fuel storage tank 78 and the fuel pump 80 to provide the fuel flow 82 in a liquid form to a heat exchanger 86 and then is delivered to the combustor 40 in gaseous form. The fuel in the storage tank 78 includes features for storing a cryogenic fuel at temperatures and/or pressures required to maintain the fuel in a liquid phase. Temperatures required to maintain the cryogenic fuel in a liquid phase may be as low as about −412° F. In one example embodiment, the cryogenic fuel is maintained at a temperature below 0° F. In another example embodiment, the fuel is maintained in the storage tank 78 at temperatures below −100° F. The cryogenic fuel may be maintained at temperatures below about −150° F. and as low as about −435° F.

The low temperatures of the cryogenic fuel 82 provide a source of heat absorption that is utilized in the bottoming cycle 54. The bottoming cycle 54 provides for recovering thermal energy otherwise lost as exhaust or waste heat through the nozzle 88.

The example bottoming cycle 54 includes the bottoming compressor 56 that is driven by the bottoming turbine 58 though a bottoming shaft 60. The working fluid 90 is circulated within the closed circuit 66 between the bottoming compressor 56 and the bottoming turbine 58. The working fluid 90 is compressed in the bottoming compressor 56, heated within the primary heat exchanger 50, and then expanded through the bottoming turbine 58 to drive the bottoming shaft 60. In one disclosed example, the shaft 60 is coupled to drive a generator 62. Although the example output shaft 60 is illustrated as driving a generator 62, other accessory components of the propulsion system 20 may be coupled to and driven by the output shaft 60.

The primary heat exchanger 50 provides thermal communication of thermal energy 48 from the exhaust gas flow 46 into the working fluid flow 90. The closed circuit 66 includes an outer portion 68 that extends from the bottoming cycle 54 to the primary heat exchanger 50. The primary heat exchanger 50 is disposed within the turbine exhaust case 32 aft of the turbine 42 and is thermal communication with heat from the exhaust gas flow 46 exiting the turbine 42.

A fuel/working fluid heat exchanger 86 places the working fluid in thermal contact with the liquid fuel flow 82. The liquid fuel flow 82 accepts heat from the working fluid 90 prior to introduction back into the bottoming compressor 56. The liquid fuel flow 82 is vaporized prior to introduction into the combustor 40 and therefore heat transferred from the working fluid 90 is utilized to heat the fuel. The exhaust heat exchanger 52 is positioned to receive fuel 82 after heating in the heat exchanger 86. The exhaust heat exchanger 52 could be removed in configurations where the fuel is sufficiently heated for introduction into the combustor 40. Moreover, additional heat may be introduced into the fuel from other heat sources other than the example exhaust gas flow as is illustrated by way of example.

Energy recovered by the bottoming cycle 54 is used to drive a generator 62 to generate electric power. The electric power may be used by any component or system of the aircraft or the gas turbine engine assembly 25. In one disclosed example, an electric motor 92 is coupled to the engine shaft 94 and is driven by at least a portion of the electric power generated by the generator 62. The electric motor 92 supplements engine power generated by the turbine 42 to aid in operation and the generation of propulsive thrust.

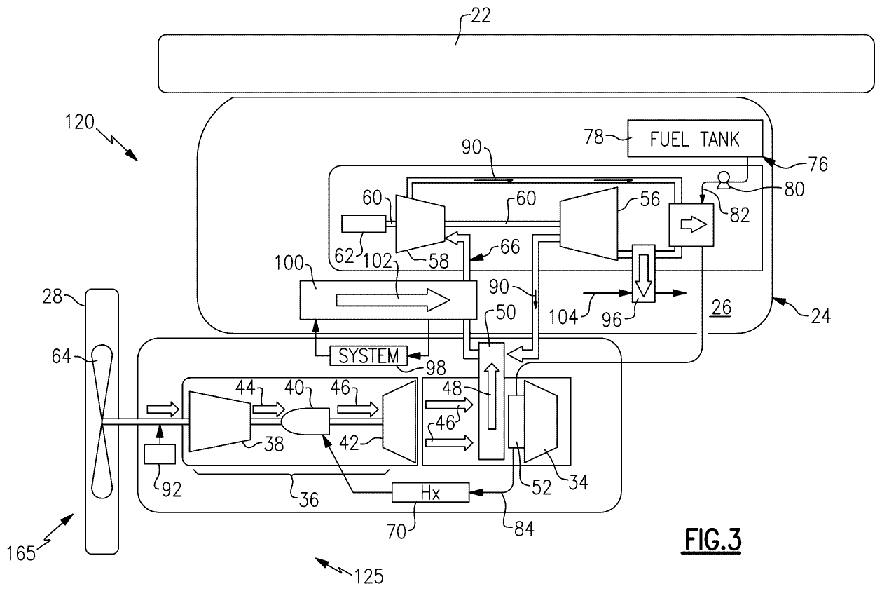

Referring to FIG. 3, another example propulsion system 120 is schematically shown and includes a gas turbine engine assembly 125 that drives a propulsion assembly 165. The example propulsion system 120 includes additional means for heating and cooling the fuel and working fluid flow 90. A secondary heat exchanger 96 provides additional cooling of the working fluid flow 90. The secondary heat exchanger 96 communicates a cooling flow 104 to the working fluid flow 90 prior to the bottoming compressor 56. The cooling flow 104 may, for example, be a cooling air flow drawn from a bypass air flow. Other cooling flows may be utilized to further cool the working fluid flow 90 of the bottoming cycle 54. Additional cooling of the working fluid flow may increase a capacity of the bottoming cycle 54 to recover thermal energy. Additionally, more heat may be input into the working fluid flow 90 by a third heat exchanger 100. The third heat exchange 100 is in thermal communication with the working fluid flow 90 before the bottoming turbine 58 to add additional thermal energy 102. The thermal energy 102 may originate from an engine system 98, such as for example, an engine lubrication system, hydraulic system, electrical system (e.g., electric control unit, motor, generator, motor/generator, etc.) or any other heat generating system of the aircraft or gas turbine engine assembly 125.

The example propulsion system 120 may further include a secondary fuel heat exchanger 70 that adds additional heat into the vaporized fuel flow 84. The additional heat added through the heat exchanger 70 further heats the fuel and advantageously utilizes heat absorption capacity of the cryogenic fuel. Heat may originate from any system including from a lubrication system, hydraulic system, electrical system, and any other heat generating system of the aircraft or gas turbine engine assembly 125.

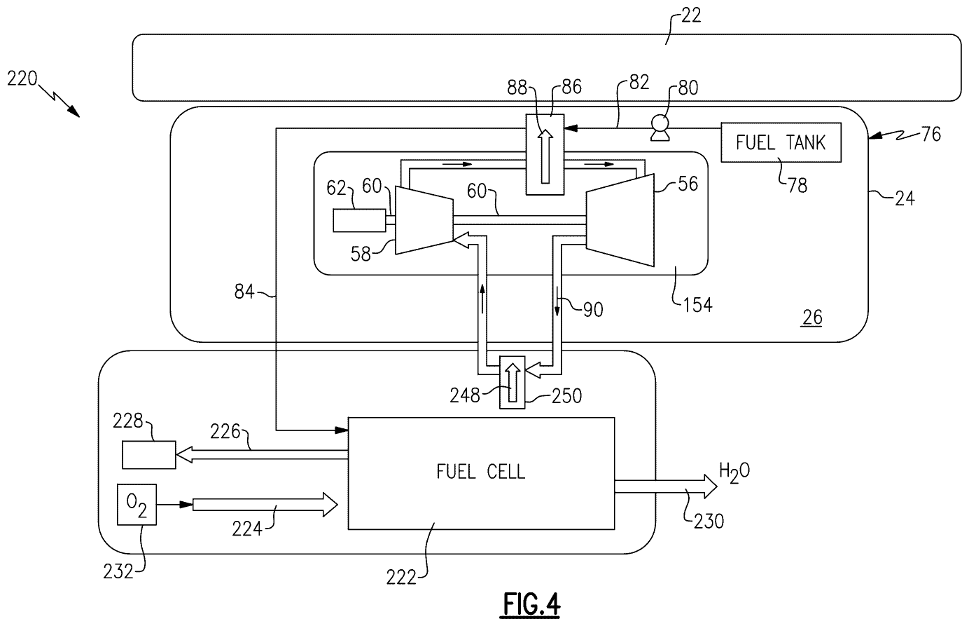

Referring to FIG. 4, another example propulsion system 220 is schematically shown and includes a bottoming cycle 154 that recovers heat generated by a fuel cell 222. The fuel cell 222 generates electric power 226 from a cryogenic fuel flow 84 and a flow of oxygen 224 and is supported on the pylon 24. The oxygen flow 224 may be provided by an oxygen source 232 on board the aircraft. The oxygen flow 224 may be separated from ambient air and/or be from the dedicated oxygen source 232. The fuel cell 222 generates electric power 226 and exhausts water 230 as a waste product. The electric power 226 may be used to power aircraft devices such as the electric motor 228 and/or propulsion systems such as the motor 92 utilized to drive the fan 64 as shown in FIGS. 1 and 2.

Operation of the fuel cell 222 generates heat as schematically shown at 248. The heat 248 is communicated into the working fluid flow 90 of the bottoming cycle 154 through a fuel cell heat exchanger 250. The bottoming cycle 154 utilizes the heated working fluid 90 to generate power in the same manner as explained with regard to the propulsion system 20 illustrated in FIGS. 1 and 2. The fuel system 76 provides a flow of vaporized fuel 84 to the fuel cell 222. A flow of fuel in a liquid state 82 is utilized to cool the working fluid 90 in a fuel/working fluid heat exchanger 86. The fuel cell 222 may be utilized as the primary energy conversion device of the propulsion system 220. The fuel cell 222 may also be utilized in combination with the core engine 36 described in reference to FIGS. 1-3. Moreover, although a core engine 36 and the fuel cell 222 are disclosed by way of example, other energy conversion devices and systems that generate heat may be utilized and are within the scope and contemplation of this disclosure.

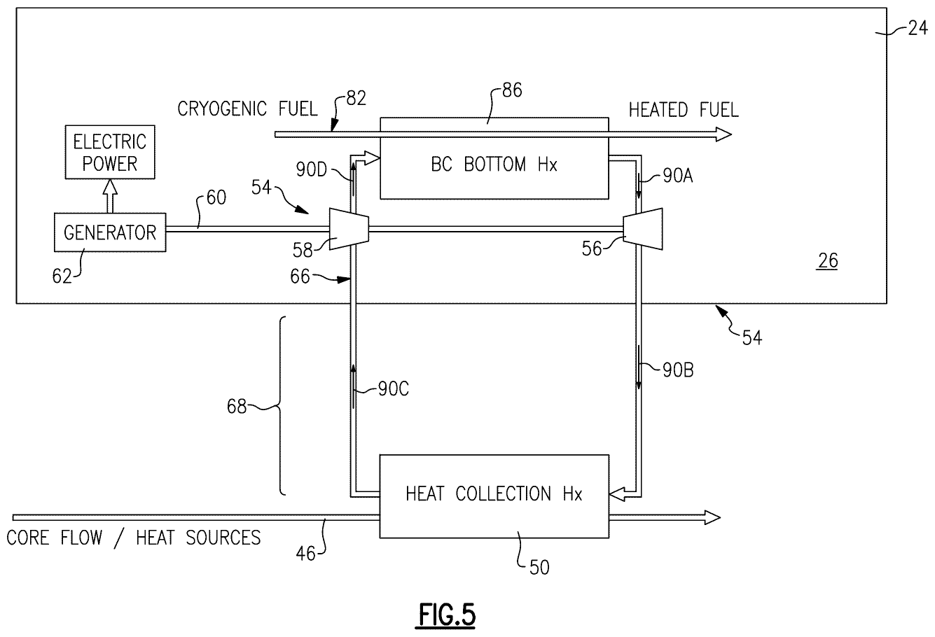

Referring to FIG. 5 with continued reference to FIG. 1, the heat exchangers of the example propulsion system are schematically shown to illustrate how thermal energy is routed between a heat source and the bottoming cycle 54.

A cooled working fluid flow indicated at 90A is communicated to the bottoming compressor 56 to generate a pressurized working fluid flow 90B. The pressurized working fluid flow 90B is communicated through a portion 68 of the closed circuit 66 that extends from the pylon 24 to the primary heat exchanger 50.

Thermal energy from various sources, including the exhaust gas flow 46 illustrated in FIG. 5 is communicated and absorbed into the working fluid flow to generate a pressurized and heated working fluid flow indicated at 90C. The pressurized and heated working fluid flow 90C is expanded through the bottoming turbine 58 to drive the shaft 60. The shaft 60 is illustrated as driving a generator 62 to generate electric power.

Working fluid flow 90D exhausted from the bottoming turbine 58 is cooled by the cryogenic fuel flow 82 in the fuel/working fluid heat exchanger 86 and communicated back to the compressor as the cooled working fluid flow 90A. The cooling provided by the cold sink provided by the cryogenic fuel flow 82 through the fuel/working fluid heat exchanger 86 provides an increased capacity for absorbing and recovering thermal energy as compared to traditional aircraft fuels. However, the example bottoming cycle 54 may use traditional aircraft fuels and remain within the contemplation and scope of this disclosure.

Accordingly, the disclosed example propulsion systems recover thermal energy with a bottoming cycle disposed and located within a pylon supporting the primary energy conversion device. Location of the bottoming cycle within the pylon simplifies incorporation of into aircraft propulsion systems to enable adoption into an increased number of aircraft architectures.

Although embodiments of this disclosure have been shown, a worker of ordinary skill in this art would recognize that modifications would come within the scope of this disclosure. For that reason, the following claims should be studied to determine the true scope and content of this disclosure.

What is claimed is:

1. An aircraft propulsion system comprising:
a primary energy conversion device that uses a cryogenic fuel and air to generate power and thermal energy;
a pylon configured to support the primary energy conversion device, the pylon including an interior space;
a bottoming cycle supported within the interior space of the pylon, the bottoming cycle including a working fluid that is circulated within a closed circuit comprising a bottoming compressor section and a bottoming turbine section, wherein the working fluid is compressed in the bottoming compressor section and expanded through the bottoming turbine section to generate shaft power;
a primary heat exchanger configured to communicate thermal energy generated by the primary energy conversion device into the working fluid; and
a fuel/working fluid heat exchanger configured to transfer thermal energy from the working fluid into the cryogenic fuel.

2. The aircraft propulsion system as recited in claim 1, further comprising a fuel system comprising a cryogenic fuel storage tank and a fuel flow path for routing a flow of the cryogenic fuel to the primary energy conversion device, wherein thermal energy is transferred into the flow of the cryogenic fuel within the fuel/working fluid heat exchanger.

3. The aircraft propulsion system as recited in claim 1, wherein the primary energy conversion device comprises a gas turbine engine comprising a combustor where a flow of the cryogenic fuel is mixed with compressed air and ignited to generate an exhaust gas flow, and the exhaust gas flow is expanded through a turbine section to generate shaft power utilized to drive a propulsive fan, wherein the exhaust gas flow is communicated through the primary heat exchanger for heating the working fluid.

4. The aircraft propulsion system as recited in claim 1, wherein the primary heat exchanger is mounted aft of the primary energy conversion device and outside of the interior space of the pylon.

5. The aircraft propulsion system as recited in claim 4, wherein the fuel/working fluid heat exchanger is mounted within the interior space of the pylon.

6. The aircraft propulsion system as recited in claim 1, further comprising a generator disposed within the interior space of the pylon, wherein the generator is driven by the bottoming turbine section through a drive shaft.

7. The aircraft propulsion system as recited in claim 1, further comprising a secondary heat exchanger configured to transfer thermal energy from a secondary heat source into the working fluid within a secondary heat exchanger.

8. The aircraft propulsion system as recited in claim 1, further comprising a bottoming cycle heat exchanger configured to communicate thermal energy from a secondary heat source into the working fluid.

9. The aircraft propulsion system as recited in claim 1, wherein a portion of the closed circuit communicates the working fluid with a cooling flow separate from the cryogenic fuel in a supplemental heat exchanger.

10. The aircraft propulsion system as recited in claim 1, wherein the primary energy conversion device comprises a fuel cell that uses the cryogenic fuel and oxygen to generate electric power.

11. An aircraft propulsion system comprising:
a core engine comprising a compressor, combustor, and turbine where a cryogenic fuel is mixed with compressed air from the compressor in the combustor and ignited to generate an exhaust gas flow that is expanded through the turbine to generate shaft power;
a propulsive fan coupled to be driven by the turbine;
a pylon configured to support the core engine and the propulsive fan, wherein the pylon comprises an interior space;
a bottoming cycle supported within the interior space of the pylon, where the bottoming cycle comprises a working fluid that is circulated within a closed circuit comprising a bottoming compressor section and a bottoming turbine section, wherein the working fluid is compressed in the bottoming compressor section and expanded through the bottoming turbine section to drive a drive shaft;
a primary heat exchanger configured to communicate thermal energy from the exhaust gas flow into the working fluid;
a fuel system comprising a cryogenic fuel storage tank and a fuel flow path for routing a flow of the cryogenic fuel to the core engine; and
a fuel/working fluid heat exchanger configured to transfer thermal energy from the working fluid to the flow of the cryogenic fuel.

12. The aircraft propulsion system as recited in claim 11, wherein the primary heat exchanger is mounted to the pylon aft of the core engine and the fuel/working fluid heat exchanger are mounted within the interior space of the pylon.

13. The aircraft propulsion system as recited in claim 12, further comprising a generator that is coupled to the drive shaft, wherein the generator is supported within the interior space of the pylon.

14. The aircraft propulsion system as recited in claim 11, wherein the fuel/working fluid heat exchanger is mounted within the interior space of the pylon.

15. The aircraft propulsion system as recited in claim 11, further comprising a secondary heat exchanger configured to transfer thermal energy from a secondary source into the working fluid.

16. The aircraft propulsion system as recited in claim 11, further comprising a bottoming cycle heat exchanger configured to transfer thermal energy from a secondary heat source into the working fluid.

17. The aircraft propulsion system as recited in claim 11, wherein a portion of the flow of working fluid within the closed circuit is in thermal communication with a cooling flow within a secondary heat exchanger.

18. A method of operating an aircraft propulsion system comprising:
communicating thermal energy from a heat source into a working fluid within a primary heat exchanger to generate a heated working fluid flow circulating within a closed circuit of a bottoming cycle supported within an interior space of a pylon;
generating shaft power with the bottoming cycle by compressing a flow of the working fluid that is communicated through the closed circuit from the interior space of the pylon to the primary heat exchanger and expanding the flow of the heated working fluid flow through a bottoming turbine section to drive a drive shaft; and
cooling the flow of the working fluid with a flow of cryogenic fuel within a fuel/working fluid heat exchanger.

19. The method as recited in claim 18, wherein the fuel/working fluid heat exchanger is disposed within the interior space of the pylon.

20. The method as recited in claim 18, further comprising communicating thermal energy from a secondary source into the flow of working fluid after heating within the primary heat exchanger.
